(19) United States
(12) Patent Application Publication
(10) Pub. No.: US 2015/0359705 A1
(43) Pub. Date: Dec. 17, 2015

(54) DISPOSABLE COVER FOR AN EXTENDABLE ELEMENT OF AN AUTOMATED CPR DEVICE

(71) Applicant: KONINKLIJKE PHILIPS N.V., Eindhoven (NL)

(72) Inventors: IGOR WILHELMUS FRANCISCUS PAULUSSEN, NEUNEN (NL); GERRIT JAN NOORDERGRAAF, DIESSEN (NL); WILLEM-JAN VAN ROOIJ, NEUNEN (NL)

(73) Assignee: KONINKLIJKE PHILIPS N.V., Eindhoven (NL)

(21) Appl. No.: 14/765,165

(22) PCT Filed: Jan. 9, 2014
(86) PCT No.: PCT/IB2014/058148

§ 371 Date: Jul. 31, 2015

Related U.S. Application Data
(60) Provisional application No. 61/760,209, filed on Feb. 4, 2013.

(51) Int. Cl. A61H 31/00

(52) U.S. Cl. CPC A61H 31/006; A61H 31/008

(57) ABSTRACT

Automated CPR unit comprising an extendable cover system including a cover dispenser (55) and a cover (50), the cover comprising a sleeve having a first closed end and a second end being connected to the cover dispenser, whereby the cover can be extended.

### FIELD OF THE INVENTION

The invention relates to the field of cardiopulmonary resuscitation, and more specifically to automated cardiopulmonary resuscitation. The invention addresses a cardiopulmonary resuscitation apparatus comprising disposable cover system.

### BACKGROUND OF THE INVENTION

Cardiopulmonary resuscitation (CPR) is a well-known technique for increasing the chance for survival from cardiac arrest. However, it is very difficult to perform manual cardiopulmonary resuscitation with consistent high quality. Since CPR quality is key for survival there is a strong drive to have a mechanical automated device to replace less reliable and long duration manual chest compressions. Automated CPR (A-CPR) apparatuses were introduced in the market recently.

An A-CPR system typically comprises a backboard and an A-CPR unit having a mechanical heart-stimulator such a compression pad, and possibly respiratory aid or electrodes for electrical resuscitation. During use, a patient is placed on the backboard, back down, and the A-CPR-unit is attached to the backboard. Document U.S. 2012/0042881 discloses one such A-CPR system with an A-CPR-unit connectable to a backboard. The backboard comprises a board element, the board element defining a plane and having a top edge, a bottom edge, a first side edge and a second side edge suitable for a variety of patients' body sizes. In order to accommodate various sizes of patient, the A-CPR unit is typically fixed at a maximum height, and the compression pad can be retracted in order to place it correctly onto the patient's sternum.

One issue with medical devices is the prevention of contamination and cleaning ability of the medical system. The common rule is that at least things that are visibly contaminated by body fluids should be sanitized and disinfected, whereas things that are not visibly contaminated should be sanitized. With the A-CPR systems, cleaning can become a real problem because the systems comprises many holes, recesses, seams, or parts which can be contaminated by dirt and/or body fluids.

It would be desirable to have an automatic CPR system which is easy to clean, in a quick way or that could at least in part avoid the need to be cleaned.

### SUMMARY OF THE INVENTION

To better address one or more of these concerns, the present invention proposes an automated cardiopulmonary resuscitation (A-CPR) unit comprising at least an extendable element, and an extendable cover system including a cover dispenser and a cover, the cover comprising a sleeve having a first closed end and a second end being connected to the cover dispenser, whereby the cover can be extended together with the extendable element.

In one embodiment, the sleeve comprises plastic or elastomeric material.

In yet another embodiment, the extendable element is a leg with a clamp element for connection to a support backboard, wherein the cover is wrapped around said leg.

Preferably, the cover dispenser is located adjacent to the clamp element.

Preferably, the extendable cover system comprises positioning and sealing means for the positioning and/or sealing in a proper position of the cover.

In yet another embodiment, the extendable element is a compression pad, and the cover is wrapped around the compression pad and is extendable together with the compression pad.

### BRIEF DESCRIPTION OF THE DRAWINGS

These and other aspects of the invention will be apparent from and elucidated with reference to the embodiment(s) described herein after, given as examples only, in which:

FIG. 1 shows a cardio pulmonary resuscitation (CPR) assembly to a first aspect of the invention;

FIG. 2A-FIG. 2C show a schematic leg which can be used in an automated cardio pulmonary resuscitation assembly of FIG. 1 with a disposable cover, in one aspect of the present invention;

FIG. 3 shows a schematic leg which can be used in an automated cardio pulmonary resuscitation assembly of FIG. 1 with a disposable cover, in one aspect of the present invention.

### DETAILED DESCRIPTION OF THE EMBODIMENTS

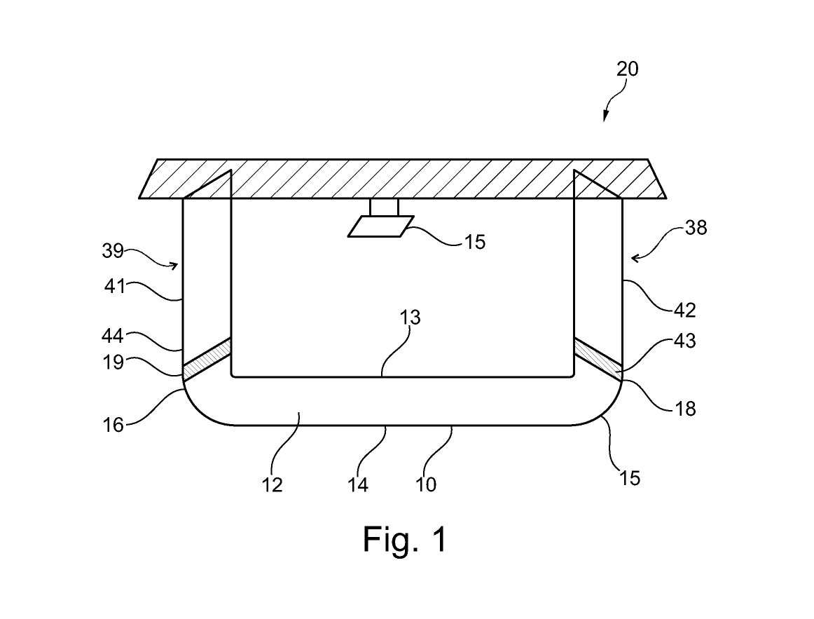

FIG. 1 shows an automated cardio pulmonary resuscitation (A-CPR) assembly according to a first aspect of the invention.

The CPR assembly 1 comprises a backboard 10 and an automated cardio pulmonary resuscitation unit 20 connectable on the backboard 10.

The backboard 10 comprises a board element 12, which is substantially planar, with a top surface 13 and a bottom surface 14. The top surface 13 is adapted to provide a rest for the back of a patient. The top surface 13 may be planar, or slightly concave to provide closer fit to the back of a patient.

The board element 12 may comprise neck support for aiding in the positioning of the patient's head relative to the backboard and/or for comfort of the patient. Shoulder stops may further be provided in order to sustain a patient on the backboard 10 when the A-CPR device 20 is operating and/or when the backboard 10 is lifted or tilted.

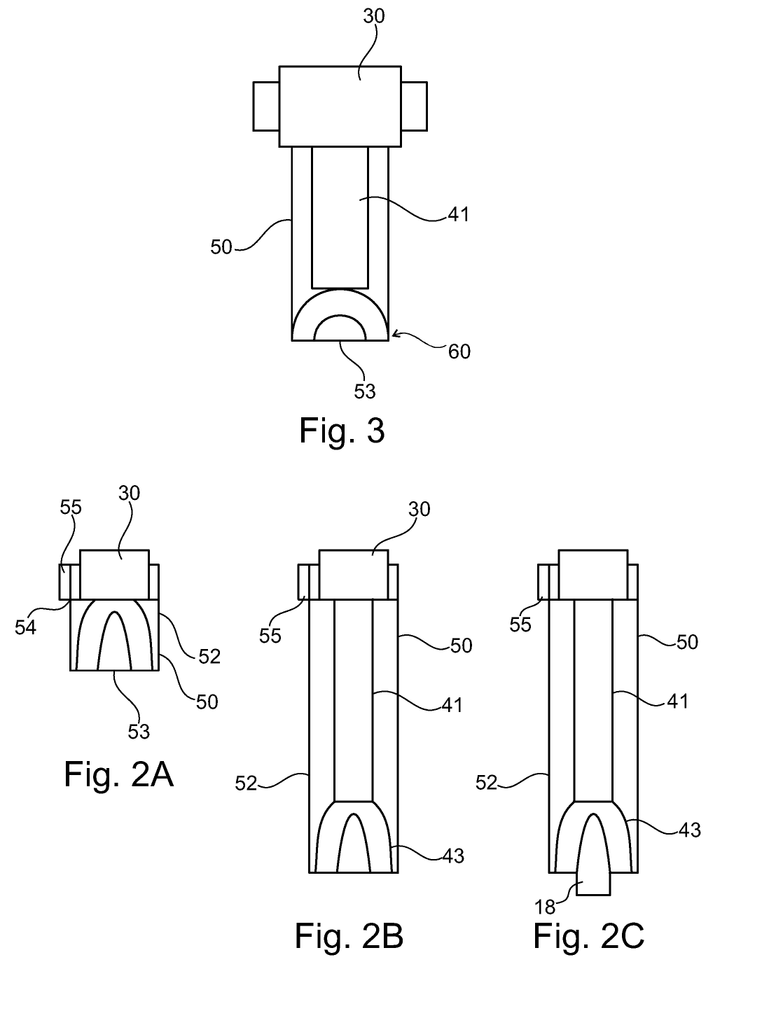

A set of connectors 18,19 is provided on the side edges 15, 16 of the board element 12. The set of connectors 18, 19 is adapted for connection of the A-CPR unit 20. The form of connectors 18, 19 is adapted to cooperate with connectors of the A-CPR unit 20. An example of connectors is shown on FIGS. 2A-2C.

The A-CPR unit 20 comprises a main body 30 with a set of connecting elements 38, 39 at the side edges 35, 36 of the main body 30. A compression pad 25 is mounted on the main body 30. The compression pad 25 is adapted to apply a compression force on a patient lying on the backboard.

The connecting elements 38, 39 comprises a set of legs 41, 42 with a clamp 43, 44 adapted to cooperate with the set of connectors 18, 19 of the backboard 10. For example, the set of connectors 18, 19 may be rails, on which the clamp 43, 44 can be locked, thereby locking the A-CPR unit 20 on the backboard 10. A user can choose to lock a first clamp 43, 44 at a time and swing the A-CPR unit 20 over to lock the second clamp 44, 43 or to lock both clamps 43, 44 simultaneously. The clamps 43, 44 can be configured to fixate the leg automatically to the backboard if enough force is applied to it.

As can be seen on FIGS. 2A-2C, the leg 41 with its clamp 43 is covered by a cover 50 intended for protecting the A-CPR unit 20 from contamination. The cover 50 is preferably a disposable cover, made of plastic or any other suitable material.

The cover 50 comprises an extendable sleeve 52 closed at a first end 53 and attached to a cover dispenser 55 at an other end 54. The sleeve 52 is placed and wrapped around the unit to be protected, here the leg 41. The cover dispenser 55 can be attached to the main body 30 of the A-CPR unit 20. Hence, as shown on FIG. 2A, the free end of the leg 53 with the clamp 43 is fully covered when retracted, for example when the A-CPR system is stored in a carry case.

When the length of the leg is varied, and in particular when the leg is extended as shown on FIG. 2B, cover material is pulled out from the cover container 55. The cover 50 is acting as a protective sleeve, without any opening on the clamp side. The leg and clamp are thereafter protected from contamination, originating from the environment or from the backboard.

When the A-CPR unit 20 is connected to the backboard 10, the leg together with the cover is pushed on the connector 18 of the backboard 10, as shown on FIG. 2C. As a result, the cover 50 is interposed between the clamp 43 and the connector 18, thereby preventing further contamination from the backboard.

The cover 50 with the cover dispenser 55 may be provided in a cover container, independent of the A-CPR system. The cover 50 can be installed on the A-CPR unit, around the leg preferably just before use of the A-CPR unit 20. After use, the cover can be removed and thrown away after use. The cover is intended to be used only once.

The person skilled in the art will readily understand that disposable leg covers allows keeping the A-CPR unit and backboard as clean as possible. The leg covers avoids as much as possible that body fluids and dirt get into the invisible/unreachable parts of the telescoping/extendable leg system.

Another advantage of using these leg covers is that the device is physically shielded from the patient which is often needed in operating room. The cleaning of the A-CPR unit at the end of the resuscitation procedure is further facilitate, the cover being removed form the device and simply thrown-away.

The extendable sleeve 52 may be provided with positioning and sealing means 60, as illustrated on FIG. 3. The positioning and sealing means 60 comprises an elastic element at the end 54, the elastic element being adapted to attach in a proper position the extendable sleeve 52 to the main body 30 of the A-CPR device. The elastic element advantageously provides watertight sealing. The positioning and sealing means 60 may further comprises a second elastic element at the closed end 53, the elastic element being adapted to attach the extendable sleeve 52 on and/or around the leg 41 in a proper position.

The cover dispenser 55 may also be provided with positioning means helping at positioning the sleeve 52 around the extendable leg.

The present invention has been described with a cover for the leg. Of course, a removable extendable cover system can also be used to protect other parts of the A-CPR device. In particular, an extendable cover can be wrapped around the compression pad, with the closed end of the sleeve covering the pad and the other end of the sleeve being on the main body unit, together with the cover dispenser.

1. An Automated-CPR A-CPR unit comprising
a main body,
at least an extendable element, and
an extendable cover system including a cover dispenser attached to the main body of the A-CPR unit and a cover intended for protecting the A-CPR unit from contamination, the cover comprising an extendable sleeve having a first closed end and a second end being connected to the cover dispenser, wherein the extendable element is a leg with a clamp element for connection to a support backboard, and wherein the cover is wrapped around said leg.

2. A-CPR unit according to claim 1, wherein the sleeve comprises plastic or elastomeric material.

3. (canceled)

4. A CPR unit according to claim 1, wherein the cover dispenser is located adjacent to the clamp element.

5. A CPR unit according to claim 1, wherein the extendable cover system comprises positioning and sealing means for the positioning and/or sealing in a proper position of the extendable sleeve.

6. A-CPR unit according to claim 1, wherein the extendable element is a compression pad, and wherein the cover is wrapped around the compression pad and is extendable together with the compression pad.
